(19) United States
(12) Patent Application Publication
(10) Pub. No.: US 2005/0014866 A1
(43) Pub. Date: Jan. 20, 2005

(54) Use of waxes as modifiers for fillers

(75) Inventors: Gerd Hohner, Gersthofen (DE); Eric Richter, Thierhaupten (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 10/893,780

(22) Filed: Jul. 16, 2004

(30) Foreign Application Priority Data
Jul. 16, 2003 (DE) 103 32 135.7

(51) Int. Cl. C08K 5/00; C08K 9/00; C09C 1/02

(52) U.S. Cl. 523/210; 106/461; 106/463; 106/464; 106/466; 106/467; 523/209; 523/215; 523/216

(57) ABSTRACT

The invention relates to the use of waxes as modifiers for fillers and relates to plastics which comprise a wax-coated filler.

The present invention is described in the German priority application No. 10332135.7, filed 16.07.2003, which is hereby incorporated by reference as is fully disclosed herein.

The invention relates to the use of waxes as modifiers for fillers and relates to thermoplastics or thermosets which comprise these waxes.

Fillers generally mean pulverulent substances of organic or inorganic origin which are dispersed in organic media, dispersions, or emulsions with the aim of giving the respective final product certain properties or lowering its production cost.

Fillers have to be divided into inorganic and organic materials. Particular importance is attached to calcium carbonate, calcium magnesium carbonate, and aluminum silicates, silicon dioxide, magnesium silicates (talc), barium sulfate, aluminum potassium sodium silicates, metals, and metal oxides, aluminum hydroxides, carbon black and graphite, wood flour and cork flour, glass fibers and natural fibers (H. P. Schlumpf, “Filler and Reinforcements” in R. Gächter, H. Müller, Plastic Additives, 3rd edition, Carl Hanser Verlag Munich 1993, pp. 525-591).

Fillers are widely used. Particular mention may be made here of the following applications related to synthetic materials: paints, coating materials, paper, construction materials, and adhesives. Depending on the application, various properties of the fillers are relevant. Typical parameters are refractive index, binder absorption, specific surface area, opacity, abrasion (process machinery wear), gloss, grain size, and grain size distribution. For specific requirements, the surface of the fillers is sometimes modified in a specific way by subjecting the fillers to surface treatment. The prior art here is the coating of, in particular inorganic, fillers with stearic acid, abietic acid, and organosilicon compounds (E. Lang et al. “Pigmente: Füllstoffe” [Pigments: Fillers] in Ullmann's Encyclopädie der technischen Chemie [Ullmann's Encyclopedia of Industrial Chemistry], Volume 18, 4th edition, Verlag Chemie, Weinheim, 1979, pp. 647-650). Depending on the production process, there are various ways of coating fillers: when fillers are being milled the coating agent can be added, so that the material becomes adsorbed onto the grains during the milling process. In the case of precipitated fillers (e.g. precipitated calcium carbonate), the coating agents can be introduced (dissolved or dispersed) into the precipitation process, whereupon the material deposits on the surface of the precipitated particles, giving a coated solid. The coating can also take place via downstream steps of the process. For example, fillers can be modified in mixers by introducing additive in the form of a solid, melt, or solution within the mixing process. Here again, the additive becomes adsorbed on the surface of the fillers (R. Wolf, B. Lal Kaul, “Plastics, Additives” in Ullmann's Encyclopedia of Industrial Chemistry, Vol A 20, fifth edition, VCH-Verlagsgesellschaft Weinheim, 1992, pp. 494-497).

In the course of the last decades, there has been a constant increase in the importance of fillers in plastics processing. In earlier times, fillers were added mainly either to lower the cost of the final product or to increase the quantity of the finished article; subsequently, however, the effect of fillers on processing properties or on finished-product properties has been utilized. Fillers could be used to optimize properties such as processing speed, dimensional stability, flammability, abrasion resistance, electrical tracking resistance, or mechanical properties. In the plastics processing sector fillers are particularly used in polyvinyl chloride, polyethylene, and polypropylene, and also in rubber (natural and synthetic non-crosslinked and crosslinked, e.g. via vulcanization, elastomers). There are only relatively few instances of addition of fillers to engineering thermoplastics (polycarbonate, polymethyl methacrylate, polyamide, polystyrene, etc.).

Typical fillers have an average grain size of a few micrometers. This gives a very large surface area. These large surfaces have high activity, depending on the chemistry and also on the preparation process for the fillers. The surfaces have reactive functional groups or are capable of adsorbing relatively large amounts of other materials. Low-molecular-weight compounds are particularly affected here, because they are preferentially adsorbed, for reasons associated with entropy. In the case of plastics, it is known that additives in particular from the plastics matrix are adsorbed on the fillers. The additives become bonded to the surface; the concentration of these materials in the plastics matrix therefore becomes lower, and they become unable to fulfill their function in the matrix. This can have an adverse effect both during processing and during the service life of the plastics item. Consequences often found are that the concentration of processing stabilizers in the molding composition decreases, making it impossible to avoid degradation of the polymer during processing. It is also known that antioxidants, light stabilizers, and UV absorbers, for example, are “deactivated” by fillers. This means that these predominantly low-molecular-weight organic substances, too, become bonded on the active surface of the filler and thus lose their ability to perform their function in the polymer matrix. A consequence of this is markedly faster aging and failure of the plastic during its service life. This effect can be countered by adding a markedly larger amount of the additives concerned, so that the required long-term properties can also be achieved. However, here too, the additional amount added is only that which is absolutely necessary, because these additives are generally very expensive substances. The surface-modified fillers mentioned exhibit only very slightly reduced adsorption of additives from the plastics matrix here.

Surprisingly, it has been found that the surface-treatment of fillers with waxes provides performance advantages. The term “wax” is understood here as defined by the Deutsche Gesellschaft für Fettwissenschaft [German society for the science of fats] to be a collective term for a large number of substances which have the following properties (cited in Fette Seifen Anstrichmittel 76, page 135, 1974) and which are either natural or obtainable (partially or entirely) by a synthetic route:
kneadable at 20° C.,
solid to brittle and hard,
coarsely to finely crystalline,
translucent to opaque, but not glassy,
melting above 40° C. without decomposition,
relatively low viscosity, even just above melting point,
highly temperature-dependent consistency and solubility,
polishable with slight pressure.

The invention therefore provides the use of waxes as modifiers for fillers.

The waxes preferably comprise synthetic or natural waxes.

The natural waxes preferably comprise petroleum waxes, montan waxes, animal waxes, and/or vegetable waxes.

The synthetic waxes preferably comprise fatty acids, fatty acid esters, fatty acid amides, Fischer-Tropsch waxes, polyolefin waxes, and/or polar-modified polyolefin waxes.

The natural waxes preferably comprise montan waxes.

Montan waxes are ester waxes and/or salts of carboxylic acids. They particularly comprise products of the reaction of the montan wax acids with polyhydric low-molecular-weight alcohols.

These reaction products comprise mixtures composed of montan wax acid, of the alcohol, of the products of partial reaction, and of the products of complete reaction of montan wax acid with the alcohol.

The alcohols particularly comprise ethylene glycol, glycerol, butanediol, pentaerythritol, dipentaerythritol, and/or trimethylolpropane.

Use as claimed in claim 1, 2, or 4, wherein the synthetic waxes comprise polyolefin waxes.

The fillers preferably comprise inorganic and/or organic fillers.

The inorganic fillers preferably comprise calcium carbonate, calcium magnesium carbonate, aluminum silicates, silicon dioxide, magnesium silicates (talc), barium sulfate, aluminum potassium sodium silicates, metals and metal oxides, and/or aluminum hydroxides.

The organic fillers preferably comprise carbon black and graphite, wood flour and cork flour, glass fibers and natural fibers, and/or organic pigments.

The amount preferably used of the waxes is from 0.05 to 10% by weight, based on the filler.

The amount particularly preferably used of the waxes is from 0.5 to 2.5% by weight, based on the filler.

The invention also provides a thermoplastic or thermoset, comprising from 0.1 to 90% by weight of a wax-coated filler.

The material preferably comprises a thermoplastic or thermoset comprising from 1 to 50% by weight of a wax-coated filler.

The thermoplastic, thermoset, or vulcanizable plastic (rubber) preferably comprises polyvinyl chloride, polyethylene, polypropylene, natural rubber, synthetic rubber, polycarbonate, polymethyl methacrylate, polyamide, styrene polymers, and/or blends composed of various plastics.

Examples of natural waxes which may be used are vegetable waxes, such as carnauba wax or candelilla wax, or waxes of animal origin, e.g. shellac wax. Suitable semisynthetic waxes are, by way of example, montan waxes which have been decolorized or, where appropriate, chemically modified, e.g. via esterification and/or via partial saponification. Appropriate materials are described by way of example in Ullmann's Encyclopedia of Industrial Chemistry, 5th Edn., Vol. A 28, Weinheim 1996 in chapters 2.2, 2.3, and 3.1-3.5, pp. 110-126.

Use may also be made of entirely synthetic non-polar or polar waxes, e.g. polyolefin waxes. Non-polar polyolefin waxes may be prepared via a thermal process to reduce the molecular weight of branched or unbranched polyolefins, or via direct polymerization of olefins. Examples of polymerization processes which may be used are free-radical processes, where the olefins, generally ethylene, are reacted at high pressures and temperatures to give waxes with a relatively high or relatively low degree of branching; and processes where ethylene and/or higher 1-olefins are polymerized with the aid of organometallic catalysts, such as Ziegler-Natta catalysts or metallocene catalysts, to give unbranched or branched waxes. Appropriate methods for preparing olefin homo- and copolymer waxes are described by way of example in Ullmann's Encyclopedia of Industrial Chemistry, 5th Edn., Vol. A 28, Weinheim 1996 in chapter 6.1.1/6.1.2 (high-pressure polymerization), chapter 6.1.3 (Ziegler-Natta polymerization, polymerization using metallocene catalysts), and also chapter 6.1.4 (thermal processes for reducing molecular weight), pp. 146-154.

Polar polyolefin waxes are produced via appropriate modification of non-polar waxes, e.g. via oxidation using air or via grafting-on of polar olefin monomers, e.g. α,β-unsaturated carboxylic acids and/or their derivatives, such as acrylic acid or maleic anhydride. it is also possible to prepare polar polyolefin waxes via copolymerization of ethylene with polar comonomers, e.g. vinyl acetate or acrylic acid; or via oxidative processes to reduce the molecular weight of relatively high-molecular-weight, non-waxy ethylene homo- and copolymers. By way of example, Ullmann's Encyclopedia of Industrial Chemistry, 5th Edn., Vol. A 28, Weinheim 1996, Chapter 6.1.5, p. 155 gives appropriate examples.

Very thin layers of the waxes described are applied to the surface of fillers. From 0.1 to 2% by weight of wax is needed to cover the surface entirely. The amount added depends on parameters such as grain size distribution, grain shape, and internal surface.

There are various ways of applying the wax to the filler surface: for example, the wax can be applied in the form of an aqueous dispersion in an existing or new step of a process. It is also possible to apply a wax melt to the filler by spraying. It is also possible to homogenize a mixture composed of filler and wax in a mixing assembly (e.g. blade mixer). If the temperature during this process is raised above the drop point of the wax, the wax becomes adsorbed onto the filler.

The wax-coated fillers do not then reduce the efficiency of the additives present in the plastics molding composition.

This is surprising, because the coating materials used nowadays, such as stearic acid or stearates, do not reduce the level of deactivation of additives. The use of specific waxes can prevent fillers from adversely affecting the effectiveness of additives. The efficiency of the additives is entirely retained even when fillers are used. This means that the amounts added of these expensive substances can continue to be very sparing.

### EXAMPLES

A commercially available chalk was coated with various waxes and compounded together with stabilizers into a commercially available polypropylene copolymer. The compounded mixtures were processed to give films and exposed to artificial weathering. A commercially available coated chalk was used as comparison, and material A therefore represents the prior art. Melt viscosities were determined by a method based on DIN 51810, using a rotary viscometer, and drop points were determined to DIN 51801/2, and acid numbers to DIN 53402.

TABLE 1
Characterization of the coating agents used

| | | | | | Acid |
|---|---|---|---|---|---|
| | | Amount | Drop | Viscosity at | number |
| | | [% by | point | 140° C. | [mg |
| No. | Coating | weight] | [° C.] | [mPa s] | KOH/g] |
| A | No additional wax | — | — | — | — |
| B | Polyethylene wax, | 0.5-3 | 112 | 300 | 60 |
| | oxidized | | | | |
| C1 | Polypropylene wax, | 0.5-3 | 158 | 600 | 40 |
| | prepared by means of | | | | |
| | Ziegler catalyst, polar- | | | | |
| | modified via grafting | | | | |
| | with maleic anhydride | | | | |
| C2 | Polypropylene wax, | 0.5-3 | 135 | 300 | 30 |
| | prepared by means of | | | | |
| | metallocene catalyst, | | | | |
| | polar-modified via | | | | |
| | grafting with maleic | | | | |
| | anhydride | | | | |
| D | Ethylene-vinyl acetate | 0.5-3 | 102 | 2500 | 23 |
| | copolymer wax, oxidized | | | | |
| E | Montan wax ester | 0.5-3 | 80 | 200 | 40 |
| | | | | at 100° C.) | |

Coating process: a mixture composed of chalk and wax was heated to the drop point of the wax in a heated fluid mixer and then mixed for a further 5 min.

Compounding process: 10% by weight of chalk and a stabilizer mixture (0.05% by weight of Hostanox O 3, 0.1.% by weight of Hostanox PAR 24, 0.1% by weight of calcium stearate, 0.5% by weight of HALS) were incorporated into polypropylene via compounding with the aid of a twin-screw extruder.

Film production: the compounded material was processed on a blown-film line to give a film bubble of thickness 100 μm.

Testing: test specimens were stamped out from the film for mechanical studies. These test specimens were weathered in a Xenotest 1200 to DIN ISO 4892, and mechanical properties were determined at regular intervals in the tensile test to DIN EN ISO 527.

The criterion for deterioration was a reduction in the tensile strain at break to 50% of the initial value.

TABLE 2
Effect of the coated fillers on the weathering resistance
of polypropylene films

| | Failure after | | |
|---|---|---|---|
| | 0.5% | 1.0% | 3.0% |
| Film with chalk | coating | coating | coating |
| A | 400 h | 400 h | 400 h |
| B | 500 h | 800 h | 850 h |
| C1 | 530 h | 850 h | 870 h |
| C2 | 550 h | 900 h | 900 h |
| D | 520 h | 850 h | 880 h |
| E | 540 h | 900 h | 920 h |

Mechanical testing of the weathered films shows that the surface modification of the chalk markedly improves the stability of the films.

1. A filler comprising a modifier, wherein the modifier is at least one wax.

2. The filler as claimed in claim 1, wherein the at least one wax is a synthetic or natural wax.

3. The filler as claimed in claim 2, wherein the natural wax is selected from the group consisting of petroleum waxes, montan waxes, animal waxes, and vegetable waxes.

4. The filler as claimed in 2, wherein the synthetic wax is selected from the group consisting of fatty acids, fatty acid esters, fatty acid amides, Fischer-Tropsch waxes, polyolefin waxes, and polar-modified polyolefin waxes.

5. The filler as claimed in claim 1, wherein the natural wax is a montan wax.

6. The filler as claimed in claim 2, wherein the synthetic wax is a polyolefin wax.

7. The filler as claimed in claim 1, wherein the filler is an inorganic or organic filler.

8. The filler as claimed in claim 8, wherein the inorganic filler is selected from the group consisting of calcium carbonate, calcium magnesium carbonate, aluminum silicates, silicon dioxide, magnesium silicates, barium sulfate, aluminum potassium sodium silicates, metals and metal oxides, and aluminum hydroxides.

9. The filler as claimed in claim 8, wherein the organic filler is selected from the group consisting of carbon black, graphite, wood flour, cork flour, glass fiber, natural fibers, and organic pigments.

10. The filler as claimed in claim 1, wherein the at least one wax is present from 0.05 to 10% by weight, based on the filler.

11. The filler as claimed in claim 1, wherein the at least one wax is present from 0.5 to 2.5% by weight, based on the filler.

12. A thermoplastic or thermoset plastic comprising from 0.1 to 90% by weight of a filler according to claim 1.

13. A thermoplastic or thermoset plastic comprising from 1 to 50% by weight of a filler according to claim 1.

14. The thermoplastic, thermally plastic as claimed in claim 12, wherein the plastic is selected from the group consisting of polyvinyl chloride, polyethylene, polypropylene, natural rubber, synthetic rubber, polycarbonate, polymethyl methacrylate, polyamide, styrene polymers, and blends thereof.

15. A vulcanizable plastic comprising a filler according to claim 1.
